(19) United States
(12) Patent Application Publication
(10) Pub. No.: US 2008/0252095 A1
(43) Pub. Date: Oct. 16, 2008

(54) Windshield protection system

(75) Inventor: Gary E. Meyers, Highlands Ranch, CO (US)

Correspondence Address: LAW OFFICE OF DALE B. HALLING, LLC, 655 SOUTHPOINTE CT, SUITE 100, COLORADO SPRINGS, CO, 80906, US

(73) Assignee: Clear Applications, Inc.

(21) Appl. No.: 11/881,251

(22) Filed: Jul. 26, 2007

Related U.S. Application Data
(63) Continuation-in-part of application No. 11/640,580, filed on Dec. 18, 2006.

(51) Int. Cl. B60J 1/20; B65D 65/22; B32B 27/00

(52) U.S. Cl. 296/95.1; 150/168; 428/412

(57) ABSTRACT

A windshield protection system has an optically clear sheet of plastic covering the windshield. The clear plastic sheet is attached to the windshield by a gasket around the perimeter of the windshield. A space is formed between the windshield and the clear plastic sheet. An optical matching material is used to fill this space. A valve in the gasket allows the optical matching material to be introduced into the space. The clear plastic sheet may have a hard coating. The clear plastic sheet protects the windshield from rocks that cause breaks, scratches and pitting. The optical matching material is a gel which increases the protection to the windshield and allows for variations in the shapes of windshields for other vehicles.

### BACKGROUND OF THE INVENTION

Windshields whether compound curved or flat, such as automobile, SUV and truck windshields, are fragile, subject to chips, scratches and pitting. Replacing a sheet of glass or windshield is expensive and time consuming. One solution is to use extremely thick sheets of glass that are much more difficult to break. However, these sheets of glass are heavy and are still subject to chips, pitting and scratches from sand rocks and other road-borne aggregate. Because of the weight of a thick sheet of glass, this is not an acceptable solution for increasing the durability of windshields. Another solution for windshields has been to provide a protective plastic layer around the outer edge of the windshield. According to the providers of this solution, most windshields purportedly break because of impacts around the edge of the windshield where the glass is subject to the windshield hold down trim stress and is therefore less durable. However, this solution still does nothing to prevent chipping, scratches and pitting over all of the windshield. In addition, the plastic layer on the outer edge of the windshield became opaque over time.

Thus there exists a need for a windshield protection system that protects the whole windshield and does not become opaque over time.

### BRIEF SUMMARY OF INVENTION

A windshield protection system that overcomes these and other problems has an optically clear sheet of plastic covering the windshield. The clear plastic sheet is attached to the windshield by a gasket around the perimeter of the windshield. A space is formed between the windshield and the clear plastic sheet. An optical matching material is used to fill this space. A vent in the gasket allows the optical matching material to be introduced into the space. The clear plastic sheet may have a hard coating on one or both sides. The clear plastic sheet protects the windshield from rocks that cause breaks, scratches and pitting. The optical matching material is a gel which increases the foreign object impact protection to the windshield and allows for variations in the shapes of windshields for other vehicles. This invention significantly increases the useful life of a windshield.

### BRIEF DESCRIPTION OF THE SEVERAL VIEWS OF THE DRAWINGS

FIG. 1 is a perspective view of a vehicle that can use the glass laminate as a windshield in accordance with one embodiment of the invention;

FIG. 2 is a cross sectional view of a glass laminate in accordance with one embodiment of the invention;

FIG. 3 is a flow chart of the steps used in a method of protecting a glass sheet in accordance with one embodiment of the invention;

FIG. 4 is a front view of a windshield protection system and a windshield in accordance with one embodiment of the invention; and

FIG. 5 is a side view of a windshield protection system and a windshield in accordance with one embodiment of the invention.

### DETAILED DESCRIPTION OF THE INVENTION

The present invention is directed to a windshield protection system that has an optically clear sheet of plastic that is adhered to a surface of a sheet of glass. A coating is applied over the clear sheet of plastic. The adhesive, plastic and coating are all resistant to UV light, which means that they will stay clear even after extended exposure to sunlight. The plastic is a hard piece of plastic that is resistant to chipping and abrasions. The coating over the plastic is even harder than the plastic. The coating further protects the plastic from chipping and abrasions. The adhesive is releasable so that the protective layer of plastic may be removed if it becomes scratched. The plastic and coating provide a significant protective barrier for the glass. This is particularly important in the case of automobile windshields. Companies with large fleets of trucks and cars spend millions of dollars every year replacing windshields. This invention significantly increases the useful life of a windshield.

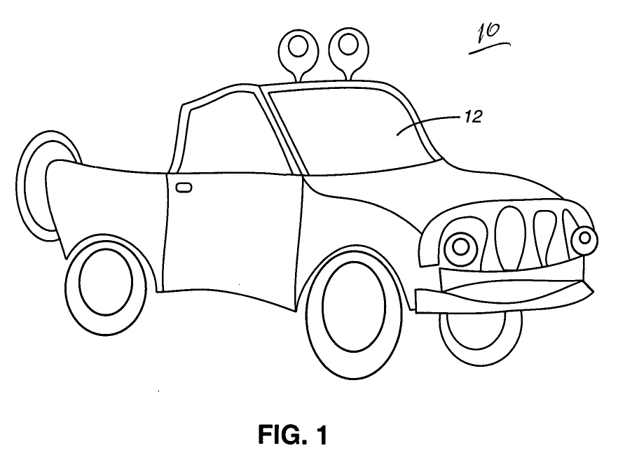

FIG. 1 is a perspective view of a vehicle that can use the a glass laminate as a windshield in accordance with one embodiment of the invention. This figure shows a truck 10 that has a windshield 12. The windshield 12 is vulnerable to scratches and chipping by rocks and other foreign objects impacting the windshield 12. By protecting the windshield 12 as described herein the life of the existing windshield 12 can be increased.

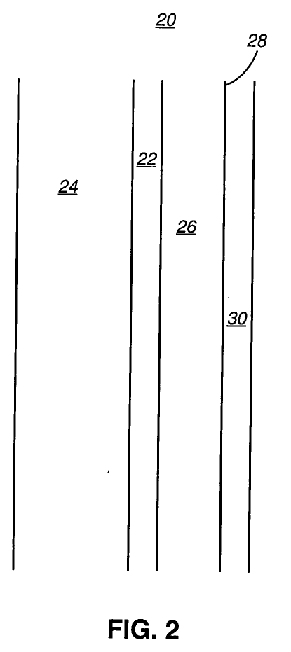

FIG. 2 is a cross sectional view of a glass laminate 20 in accordance with one embodiment of the invention. An optically clear adhesive 22 is applied to a sheet of glass 24. The sheet of glass 24 can be any ordinary sheet of glass, however the invention is particularly useful and cost effective for windshields of vehicles. The adhesive 22 is optically clear and Ultra-Violet (UV) light resistant. UV resistant means that the adhesive 22 will not yellow or become opaque when exposed to intense sunlight for an extended period of time. A clear rigid plastic 26 is adhered to the glass 24 by the adhesive 22. In one embodiment, the clear rigid plastic 26 is acrylic, polycarbonate, polyester alloy or similar material (hereafter called ‘plastic’). The sheet of ‘plastic’ 26 is cleaned with isopropyl alcohol before being applied to the adhesive in one embodiment. The ‘plastic’ 26 is pressed against the glass 24 to spread the adhesive 22 in order to cover the entire bonding area. In one embodiment, the adhesive is “DYMAX Ultra Light Weld® 3099 Series” adhesive available from DYMAX corporation 51 Greenwoods Road, Torrington, Conn. 06790. Once the ‘plastic’ 26 is pressed against the adhesive 22 the adhesive is cured by applying high intensity visible and/or UV light. In one embodiment, the high intensity light is provided by a “5000-EC” lamp available from DYMAX. The high intensity light is applied for 20 seconds in one embodiment.

The exposed surface 28 of the acrylic panel 26 is then cleaned with hexane and isopropanol. Next, the exposed surface 28 is blown with ionized nitrogen. The coating 30 is then applied to the ‘plastic’ panel 26. The coating 30 is optically clear and is UV resistant, abrasion resistant and resistant to attacks by common chemicals. In addition, the clear coating is harder than the ‘plastic’ panel 26. The coating 30 may be applied in a temperature and humidity controlled Class 100 environment. The coating is then dried under ambient conditions for 30 minutes and then cured in an oven at 82 degrees centigrade for four hours. In one embodiment, the coating is “CrystalCoat™ MP 100 or MP 124” from SDC Technologies, 1911 Wright Circle, Anaheim, Calif. 92806. The MP 100 adhesive is a polysiloxane based thermal cure coating. Note that while acrylic or polycarbonate is the presently preferred plastic material, polyurethane, polyester alloy and/or other semi-rigid, rigid and thermoformable optically clear plastics may be used.

In the case of a windshield, which is not generally a flat piece of glass, the plastic sheet has to be formed and cut into the same shape as the windshield. Generally, the plastic will completely cover the windshield, however there may be applications where only part of the windshield is covered. If the coating/plastic become scratched or chipped the adhesive is releasable. In one embodiment, the adhesive is released by applying high temperatures that the windshield would not encounter during operation of the vehicle. The old plastic/coating is then removed and a new plastic/coating is applied to protect the windshield.

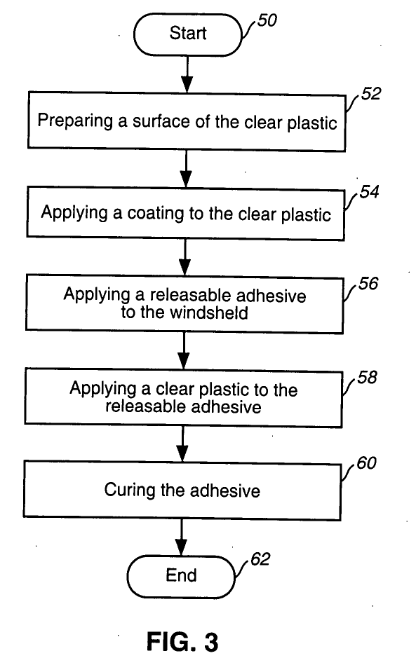

FIG. 3 is a flow chart of the steps used in a method of protecting a glass sheet in accordance with one embodiment of the invention. The process starts, step 50, by preparing a surface of a clear plastic at step 52. Next, a coating is applied to the clear plastic at step 54. A releasable adhesive is applied to the windshield to the plastic at step 56. The clear plastic is applied to the releasable adhesive at step 58. At step 60, the adhesive is cured, which ends the process at step 62. Note that in the embodiment, the plastic is first shaped by thermoforming, or vacuum formed to produce a conformable shape that matches the convex shape of the windshield. In another embodiment, the adhesive is applied to the plastic at step 56 instead of to the windshield. Either way the adhesive bonds the windshield to the plastic. Note that the plastic is manually pressed onto the windshield. Commonly, a machine is needed to press a piece of plastic to glass to obtain an optically clear adhered combination. However, the present invention accomplishes this without the need for high pressures that require a machine.

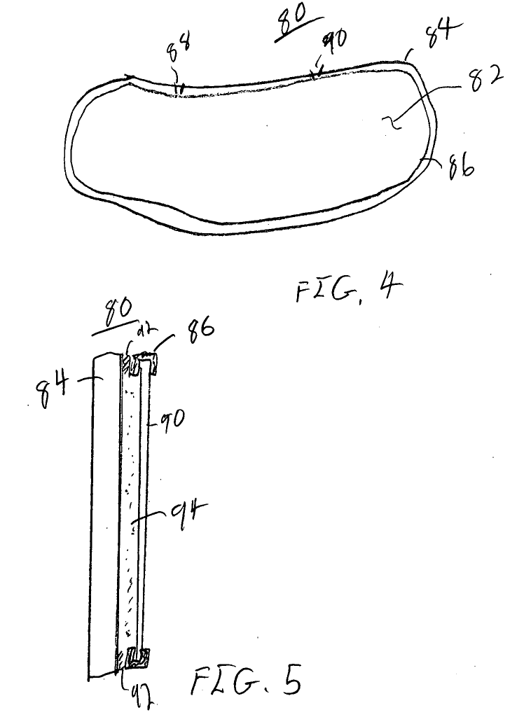

FIG. 4 is a front view of a windshield protection system 80 and a windshield 84 in accordance with one embodiment of the invention. This figure shows a gasket 86 that is attached to a perimeter of the windshield 84. The gasket 86 in on embodiment is adhered to windshield, although other methods of attachment may also be used. The gasket 86 holds a clear plastic sheet. The gasket 86 may be made of any weather proof elastomeric material. The gasket 86 has inlet 88 for the introduction of an optical matching material. The inlet 88 may be a valve. An air vent 90 is used to vent air from a space between the windshield 84 and the clear plastic sheet when the optical matching material is injected.

FIG. 5 is a side view of a windshield protection system 80 and a windshield 84 in accordance with one embodiment of the invention. A clear plastic sheet 90 is held in place by the gasket 86. The gasket 86 is adhered 92 to the windshield 84. An optical matching material 94 fills the space between the windshield 84 and the clear plastic sheet 90. The clear plastic sheet may be made of polycarbonate or acrylic or other optically clear, sun/weather stable plastic that provides sufficient protection against rocks and other flying objects. In one embodiment, the clear plastic sheet has a hard coating covering its surface. This further resists scratches and pitting of the plastic sheet 90. The optical matching material is an optical gel in one embodiment. The optical matching material has an index of refraction that is approximately equal to the index of refraction of the clear plastic sheet. A suitable optical gel is made by Nye Lubricants, Inc. of Fairhaven, Mass. 02719 and is sold under the name SmartGel®. The use of an optical matching gel provides several advantages. One is that the optical matching gel 94 provides additional protection to the windshield 84 from impacts by absorbing some of the force of any foreign object impacts. Another advantage of the optical matching material is that it allows for variations in the shapes of windshields. The clear plastic sheet 90 has to have essentially the same shape as the windshield 84, but manufacturing variations in windshields cause enough variation that it can be difficult to obtain an exact match. The optical matching material makes it easier to adjust for variations in the shapes of windshields. Note that in one embodiment the clear plastic sheet has a thickness of around ⅛^{th} inch and the space between the clear plastic sheet 90 and the windshield 84 is an ⅛^{th} an inch or less. The clear plastic sheet 90 may be adhered to the gasket 86 in one embodiment. When the clear plastic sheet 90 becomes scratched or pitted the gasket 86 makes it easy to remove clear plastic sheet 90 and place a new clear plastic sheet 90 over the windshield.

Thus there has been described a windshield protection system that is easy to install, easy to repair and results in windshields being protected significantly longer than unprotected windshields.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A windshield protection system, comprising:
a gasket attached to a windshield;
a clear ‘plastic’ sheet attached to the gasket; and
an optical matching material between the clear ‘plastic’ sheet and the windshield.

2. The system of claim 1, wherein the gasket is adhered to the windshield.

3. The system of claim 2, wherein the gasket has an inlet.

4. The system of claim 3, wherein the gasket has an air vent.

5. The system of claim 2, wherein the gasket is placed on a perimeter of the windshield.

6. The system of claim 1, wherein the optical matching material has an index of refraction that is essentially the same as the clear ‘plastic’ sheet.

7. The system of claim 6, wherein the clear ‘plastic’ has a hard coating.

8. A windshield protection system, comprising:
a clear plastic sheet attached to a windshield and providing a space between the plastic sheet and the windshield; and
a optical matching material filling the space between the clear plastic sheet and the windshield.

9. The system of claim 8, wherein the clear plastic sheet is made of polycarbonate.

10. The system of claim 9, wherein the polycarbonate has a hard coating.

11. The system of claim 8, wherein the clear ‘plastic’ sheet is attached with a gasket.

12. The system of claim 11, wherein the gasket has an inlet valve.

13. The system of claim 11, wherein the gasket is adhered to the windshield.

14. The system of claim 13, wherein the clear ‘plastic’ sheet is adhered to the gasket.

15. The system of claim 8, wherein the clear ‘plastic’ sheet is made of acrylic.

16. The system of claim 8, wherein the optical matching material is gel.

17. The system of claim 16, wherein the optical matching material has an index of refraction that is approximately equal to the index of refraction of the clear plastic sheet.

18. The system of claim 8, wherein the clear ‘plastic sheet has approximately the same shape as the windshield.
